(19) United States
(12) Patent Application Publication
(10) Pub. No.: US 2025/0250212 A1
(43) Pub. Date: Aug. 7, 2025

(54) SUSTAINABLE SUPERABSORBENT HYDROGELS

(71) Applicant: TEXAS STATE UNIVERSITY, San Marcos, TX (US)

(72) Inventors: Sujata Mandal, San Marcos,, TX (US); Sangchul Hwang, San Marcos,, TX (US)

(73) Assignee: TEXAS STATE UNIVERSITY, San Marcos, TX (US)

(21) Appl. No.: 19/040,613

(22) Filed: Jan. 29, 2025

Related U.S. Application Data
(60) Provisional application No. 63/548,991, filed on Feb. 2, 2024.

(51) Int. Cl. C05G 5/40; C05C 11/00; C05D 9/00; C05F 11/00; C08J 3/075

(52) U.S. Cl. CPC C05G 5/40; C05C 11/00; C05D 9/00; C05F 11/00; C08J 3/075

(57) ABSTRACT

The present disclosure pertains to a hydrogel that includes one or more galactomannans; one or more biodegradable polymers; and one or more clays. The present disclosure also pertains to methods of treating a soil by adding a hydrogel of the present disclosure to the soil. The present disclosure also pertain to methods of making hydrogels by associating one or more galactomannans with at least one or more biodegradable polymers and one or more clays.

### CROSS-REFERENCE TO RELATED APPLICATIONS

This application claims priority to U.S. Provisional Patent Application No. 63/548,991, filed on Feb. 2, 2024. The entirety of the aforementioned application is incorporated herein by reference.

### BACKGROUND

A need exists for compositions that can effectively retain water and nutrients for numerous applications, such as in agriculture. Numerous embodiments of the present disclosure aim to address the aforementioned need.

### SUMMARY

In some embodiments, the present disclosure pertains to a hydrogel that includes one or more galactomannans; one or more biodegradable polymers; and one or more clays. In some embodiments, the hydrogels of the present also include one or more compounds. In some embodiments, the compounds include, without limitation, nutrients, agrochemicals, pesticides, herbicides, fertilizers, or combinations thereof.

Additional embodiments of the present disclosure pertain to methods of treating a soil by adding a hydrogel of the present disclosure to the soil. In some embodiments, the soil may be associated with an agricultural field, such as a farm. In some embodiments, the addition of the hydrogels of the present disclosure to a soil enhances the growth rate of plants or seeds. In some embodiments, the methods of the present disclosure also include a step of growing the plants or seeds in the soil.

Further embodiments of the present disclosure pertain to methods of making hydrogels by associating one or more galactomannans with at least one or more biodegradable polymers and one or more clays. In some embodiments, the associating includes: (1) mixing the galactomannans with the biodegradable polymers to form a mixture; and (2) adding the clays to the mixture. In some embodiments, the mixing includes heating the mixture at temperatures ranging from about 50° C. to about 60° C. for at least 1 hour.

The hydrogels of the present disclosure can have various advantageous properties. For instance, in some embodiments, the hydrogel is biodegradable. In some embodiments, the hydrogel is operable to retain water at more than 500 times the hydrogel's weight, at more than 600 times the hydrogel's weight, at more than 700 times the hydrogel's weight, or at more than 800 times the hydrogel's weight.

### FIGURES

FIG. 1 illustrates the synthesis of a Superabsorbent Hydrogel (SH) from natural gum-based polysaccharides.

FIGS. 2A-2C illustrate the gelling behavior of SH with GG-2% (FIG. 2A), GG-2% and Chitosan (FIG. 2B), and GG-2% with Chitosan and Kaolin (FIG. 2C).

FIGS. 3A-3C show images of a dry SH (FIG. 3A), SH after 30 minutes of water absorption (FIG. 3B), and SH after 2 hours of water absorption (FIG. 3C).

FIG. 4 shows a swelling test of the SH hydrogels at pH 4, pH 9, and NaCl (1%).

FIG. 5 shows a chlorophyll test of the SH hydrogels with black chickpeas leaves.

FIGS. 6A-6C show the germination of black chickpea seeds exposed to SH hydrogels after 7 days of germination (FIG. 6A), 14 days of germination (FIG. 6B), and 40 days of germination (FIG. 6C).

FIGS. 7A-7B show images of fenugreek seeds (FIG. 7A) and chickpeas (FIG. 7B) exposed to SH hydrogels.

FIGS. 8A-8D show images of chickpeas exposed to SH hydrogels, which illustrate their biodegradable and biocompatible nature.

FIGS. 9A-9C show the rapid growth of plants exposed to different SH hydrogels.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components that includes one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials define a term in a manner that contradicts the definition of that term in this application, this application controls.

A need exists for compositions that can effectively retain water and nutrients. For instance, due to the rapid depletion of groundwater reserves and the unpredictability of rainfall in arid and semiarid regions, many regions of the world are facing desertification.

Additionally, limited water resources and more food demand are the two key challenges in agriculture. Thus, agriculture is the most drought-sensitive area of the world's economy. Moreover, food security has become a global concern with many basic food crops growing in areas with high drought risk.

To improve soil water holding capacity, hydrogels are a promising solution to food security and agriculture. However, commercial hydrogels derived from synthetic petroleum-based materials are non-biodegradable. Furthermore, such hydrogels can break down into microplastics, infiltrate soil and water sources, and endanger ecosystems and aquatic ecology.

Additionally, hydrological drought has posed a serious threat to crop yield. Hence, various technologies have been invented to tackle hydrological drought, such as drip irrigation systems and low-pressure micro-sprinklers. However, these technologies are energy intensive, require skilled labor, have high operational costs, and are mostly applied for high-value crops. Accordingly, the limits of such technologies have compelled researchers to develop more accessible approaches to drought resistance.

Moreover, given the growing interest in environmental protection issues, a tremendous concern has been focused on the development of superabsorbent materials based on biodegradable and nontoxic polymers that have properties resembling the traditional superabsorbent polyacrylics.

In sum, a need exists for compositions that can effectively retain water and nutrients for numerous applications, such as in agriculture. In particular, the urgency to address water scarcity and the need for sustainable water management in agriculture necessitates the exploration and implementation of innovative solutions. Numerous embodiments of the present disclosure aim to address the aforementioned need.

In some embodiments, the present disclosure pertains to a hydrogel that includes one or more galactomannans; one or more biodegradable polymers; and one or more clays. Additional embodiments of the present disclosure pertain to methods of treating soil by adding a hydrogel of the present disclosure to the soil. Further embodiments of the present disclosure pertain to methods of making hydrogels by associating one or more galactomannans with at least one or more biodegradable polymers and one or more clays. As outlined in more detail herein, the hydrogels, soil treatment methods, and hydrogel fabrication methods of the present disclosure can have numerous embodiments.

### Galactomannans

The hydrogels of the present disclosure may include various galactomannans. Additionally, the hydrogel fabrication methods of the present disclosure may utilize various galactomannans. For instance, in some embodiments, the galactomannans include, without limitation, guar gum, fenugreek gum, xanthan gum, locust bean gum, Arabic gum, tara gum, cassia gum, or combinations thereof. In some embodiments, the galactomannans include guar gum.

### Biodegradable Polymers

Biodegradable polymers refer to polymers that are capable of breaking down completely through the action of microorganisms. For instance, in some embodiments, the biodegradable polymers may break down into natural byproducts, such as gases (e.g., CO₂, N₂), water, biomass, and inorganic salts.

The hydrogels of the present disclosure may include various biodegradable polymers. Additionally, the hydrogel fabrication methods of the present disclosure may utilize various biodegradable polymers. For instance, in some embodiments, the biodegradable polymers include, without limitation, agro-polymers, polysaccharides, proteins, biopolymers, bio-polyesters, polylactic acid, or combinations thereof.

In some embodiments, the biodegradable polymers include one or more polysaccharides. In some embodiments, the polysaccharides include, without limitation, starch, glycogen, galactogen, arabinoxylans, cellulose, chitin, chitosan, pectin, or combinations thereof. In some embodiments, the polysaccharides include chitosan.

### Clays

The hydrogels of the present disclosure may include various clays. Additionally, the hydrogel fabrication methods of the present disclosure may utilize various clays. For instance, in some embodiments, the clays include, without limitation, kaolin clays, kaolinite clays, ball clays, fire clays, bentonite clays, or combinations thereof. In some embodiments, the clays include kaolin clays and kaolinite clays.

### Compounds

In some embodiments, the hydrogels of the present also include one or more compounds. In some embodiments, the hydrogel fabrication methods of the present disclosure also include a step of associating the hydrogel with one or more compounds.

The hydrogels of the present disclosure may be associated with various compounds. For instance, in some embodiments, the compounds include, without limitation, nutrients, agrochemicals, pesticides, herbicides, fertilizers, or combinations thereof.

In some embodiments, the hydrogels of the present disclosure can be utilized as carriers of nutrients and other agrochemicals into soil. For instance, in some embodiments, the hydrogels of the present disclosure can be utilized to deliver pesticides (e.g., liquid pesticides) and herbicides into soil for controlled applications. In some embodiments, the hydrogels of the present disclosure can be utilized for the controlled delivery of fertilizers to plants.

### Properties

The hydrogels of the present disclosure can have various advantageous properties. For instance, in some embodiments, the hydrogels of the present disclosure are biodegradable.

In some embodiments, the hydrogels of the present disclosure are operable to retain water at more than 500 times the hydrogel's weight. In some embodiments, the hydrogels of the present disclosure are operable to retain water at more than 600 times the hydrogel's weight. In some embodiments, the hydrogels of the present disclosure are operable to retain water at more than 700 times the hydrogel's weight. In some embodiments, the hydrogels of the present disclosure are operable to retain water at more than 800 times the hydrogel's weight.

The hydrogels of the present disclosure can be in various forms. For instance, in some embodiments, the hydrogels of the present disclosure are in the form of a pellet. In some embodiments, such hydrogel pellets can be utilized to help soil retain moisture, soil health, and water availability in various environments, such as arid and/or semi-arid zones.

### Methods of Treating a Soil

Additional embodiments of the present disclosure pertain to methods of treating a soil by adding a hydrogel of the present disclosure to the soil. Various methods may be utilized to add the hydrogels of the present disclosure to a soil. For instance, in some embodiments, the addition occurs by mixing, sprinkling, spraying, insertion, or combinations thereof. In some embodiments, the hydrogels of the present disclosure can be added to the soil by either mixing with soil or insertion into the soil.

The hydrogels of the present disclosure may be added to various soils. For instance, in some embodiments, the soil is associated with an agricultural field. In some embodiments, the soil is associated with a farm. In some embodiments, the soil includes a sandy soil. In some embodiments, the soil is a clay soil. In some embodiments, the hydrogels of the present disclosure may be added to a soil (e.g., a sandy soil and/or clay soil) to enhance water retention capacity.

The soil treatment methods of the present disclosure can have various effects. For instance, in some embodiments, the addition of the hydrogels of the present disclosure to a soil reduces the rate of soil degradation. In some embodiments, the addition of the hydrogels of the present disclosure to a soil conditions the soil. In some embodiments, the addition of the hydrogels of the present disclosure to a soil results in the sustained release of compounds associated with the hydrogels (e.g., fertilizers coated on the hydrogels).

In some embodiments, the addition of the hydrogels of the present disclosure to a soil enhances the growth rate of plants or seeds. In some embodiments, the methods of the present disclosure also include a step of growing the plants or seeds in the soil. In some embodiments, the plant or seed includes, without limitation, maize, rice, bean, soybean, common bean, pinto bean, corn, cotton, wheat, N. benthamiana, Arabidopsis, tobacco, tomato, lettuce, potato, grapes, sorghum, varieties thereof, or combinations thereof.

### Methods of Making Hydrogels

Additional embodiments of the present disclosure pertain to methods of making a hydrogel of the present disclosure by associating one or more galactomannans with at least one or more biodegradable polymers and one or more clays. In some embodiments, the associating includes mixing the galactomannans with the biodegradable polymers and the clays to form a mixture. In some embodiments, the associating further includes heating the mixture. In some embodiments, the heating includes heating the mixture at temperatures ranging from about 50° C. to about 60° C. In some embodiments, the heating occurs for at least 1 hour.

In some embodiments, the associating includes: (1) mixing the galactomannans with the biodegradable polymers to form a mixture; and (2) adding the clays to the mixture. In some embodiments, the mixing includes heating the mixture. In some embodiments, the heating includes heating the mixture at temperatures ranging from about 50° C. to about 60° C. In some embodiments, the heating occurs for at least 1 hour.

### Applications and Advantages

The present disclosure provides numerous advantages. In particular, the hydrogels of the present disclosure provide a natural hydrogel that displays high water absorption capabilities and biodegradability.

For instance, in some embodiments, the hydrogels of the present disclosure display water absorption capabilities greater than the most widely used synthetic hydrogels. In particular, potassium polyacrylate-based hydrogels retain water at about 300-500 times their weight. On the other hand, in some embodiments, the hydrogels of the present disclosure can retain water at about 700-850 times their weight.

Moreover, the hydrogels of the present disclosure provide a safer and less toxic alternative to synthetic hydrogels. In particular, the hydrogels of the present disclosure utilize all-natural hydrogel feedstocks, which are readily available within the commercial marketplace. Furthermore, the methods of the present disclosure provide a mechanism to produce such hydrogels through a relatively benign and facile manufacturing procedure.

As such, the hydrogels of the present disclosure can find numerous applications. For instance, in some embodiments, the hydrogels of the present disclosure can find applications for farming practices. In some embodiments, the hydrogels of the present disclosure, which have high water absorption capabilities, can be utilized for soil conditioning. In some embodiments, the hydrogels of the present disclosure can be used to lower water and nutrient loss, such as from evaporation and runoff, thereby reducing considerably water and fertilizer usage, and encouraging effective resource use.

Additionally, the hydrogels of the present disclosure can be utilized to reduce the rate of soil degradation by improving soil fertility, stabilizing soil surfaces, and stabilizing soil structure through water and nutrient retention mechanisms. Furthermore, since the hydrogels of the present disclosure are biobased, they present minimum environmental impact. On the other hand, non-biodegradable hydrogel buildup has the potential to disturb natural ecosystems and alter their balance.

### Additional Embodiments

Reference will now be made to more specific embodiments of the present disclosure and experimental results that provide support for such embodiments. However, Applicants note that the disclosure herein is for illustrative purposes only and is not intended to limit the scope of the claimed subject matter in any way.

### Example 1. Development of Sustainable Superabsorbent Hydrogels

Hydrogels made of biopolymers are more environmentally friendly and biodegradable than those made of synthetic materials, such as petrochemicals. Furthermore, utilizing biocompatible and renewable polymers lessens their potential for long-term buildup in soil and their negative effects on the environment.

The exploration of hydrogels-based natural plant gums and chemically derivatized plant gums have received tremendous applications in pharmaceutical, food, cosmetics, and environmental remediation due to their economic viability, sustainability, nontoxicity, biodegradability, and biocompatibility. This fits with the desire to attenuate reliance on non-renewable resources and the rising demand for sustainable agriculture practices.

The primary objective of this Example is to develop robust and sustainable bio-polymeric hydrogels that are derived from natural polysaccharides, that are superabsorbers of water, and that can be used for the controlled delivery of fertilizers and nutrients to plants to improve plant viability and total crop yield.

Natural nontoxic polysaccharides (e.g., guar gum, xanthan gum, fenugreek gum, Tara gum, Arabic gum, and/or locust bean gum) can form gel and viscous solutions simultaneously and are commonly used to obtain hydrogels with improved biocompatibility and efficacy. This Example provides the fabrication of natural polysaccharides-based hydrogels using natural gums (e.g., guar gum, xanthan gum, locust bean gum, and/or Tara gums) as raw materials by a facile and quick method.

Guar gum (GG), a naturally occurring and nonionic polymer, with high molecular weight extracted from the seeds of Cyamopsis tetragonolobus (a leguminous plant) is hydrophilic, relatively cheap, biocompatible, and biodegradable. These characteristics make GG an ideal candidate to be used in agriculture, the pharmaceutical industry, food, textile, paper, petroleum, mining, explosives, and pharmaceuticals as high-water effective thickeners and stabilizers.

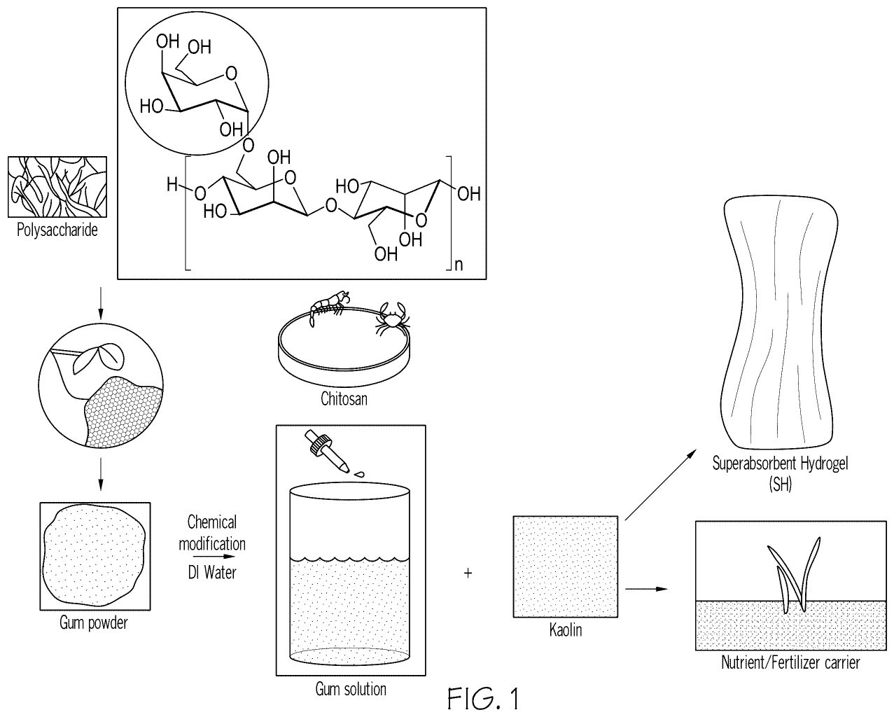

In this Example, GC was modified to develop a robust biodegradable hydrogel. Additionally, GC's efficacy in terms of gelling property, swelling ratio, moisture retention, and release characteristics was further investigated. As illustrated in FIG. 1, GG (2% and 4% w/v) was treated with chitosan (C), a nontoxic water-soluble polysaccharide extracted from shells of crabs and shrimps. The above mixture was continuously stirred at about 50-60° C. for 1 h without any addition of plasticizer, and it was further treated with kaolin or Kaolinite (K), a laminar mineral from the clay kind, composed of planar layers of octahedral alumina and tetragonal silica. Kaolinite or Kaolin molecules in the GG membrane structure may help the diffusion between the polymer matrix and filler particles, enhancing both membrane selectivity and the flux, independently of the developed mixed matrix being porous or dense.

Kaolin also offers superior mechanical strength to the matrix. Different concentrations of Guar Gum with fixed amounts of Chitosan and kaolin were mixed to make a blend viz (2% GG (G2), 2% GG with chitosan (G2C), 2% guar gum with kaolin (G2 K), 2% guar gum with kaolin and chitosan (G2CK), 4% GG (G4), 4% GG with chitosan (G4C), 4% guar gum with kaolin (G4 K), and 4% guar gum with kaolin and chitosan (G4CK). The formulation is shown in Table 1.

TABLE 1
Formulation table -for different samples and control.

| Fenugreek Sample list | Chickpeas Sample list |
|---|---|
| G2-F | G2-B |
| G2K-F | G2K-B |
| G2C-F | G2C-B |
| G2CK-F | G2CK-B |
| G4-F | G4-B |
| G4K-F | G4K-B |
| G4C-F | G4C-B |
| G4CK-F | G4CK-B |
| Control A-F | Control A-B |
| Control B-F | Control B-B |

To explore the performance of the prepared hydrogels, two controls were prepared: Control A and Control B with model plants Fenugreek (-F) and Black Chickpeas (-B). The gelling behavior and the swelling characteristics of the synthesized hydrogels were investigated using distilled water, buffer solution at pH 4.0, pH 9.0, and brine. Additionally, using model plants, the effectivity of SH hydrogel on the germination and growth of model plants were examined. The leaves of the growing plants were dissolved in 80-90% acetone followed by centrifugation (2000 rpm for 5-10 minutes) and then left in a refrigerator for 30-40 hours for the dark reaction to continue. The color intensity of the green pigment for the leaves was read using a spectrophotometer. Chlorophylls exhibit two major light absorption bands, one on the blue side of the visible spectrum (<460 nm) and one in the red (630-670 nm).

### Example 1.1. Gelling Properties of the Hydrogels

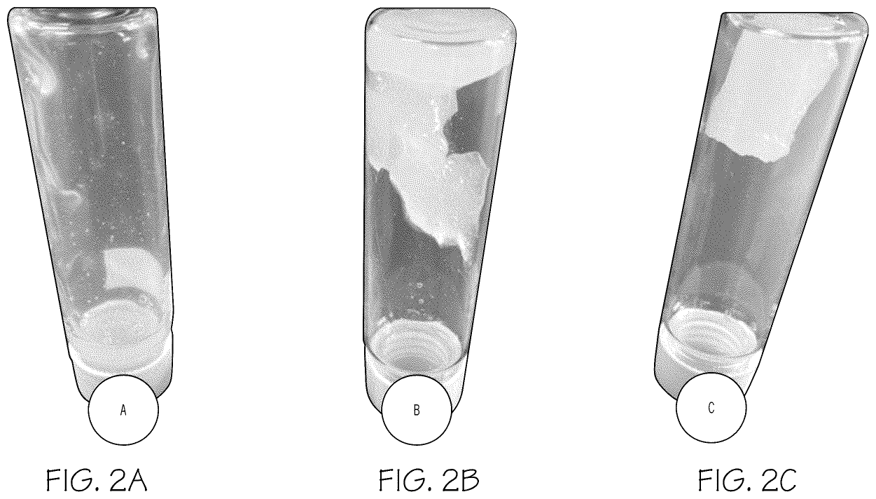

Gelation is an important parameter for the successful fabrication of gels. FIGS. 2A-2C exhibit the gelation behavior of the hydrophilic biopolymers by a bottom-up strategy.

### Example 1.2. Water Absorption

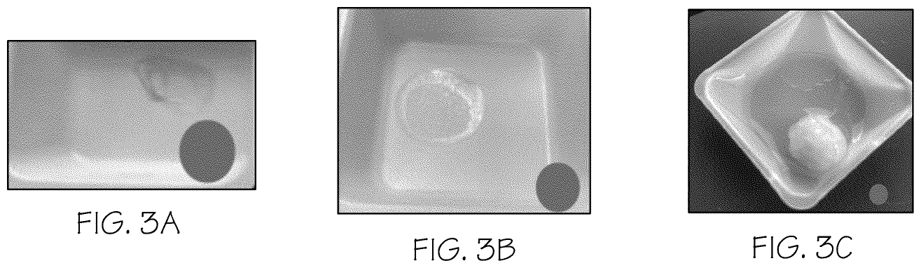

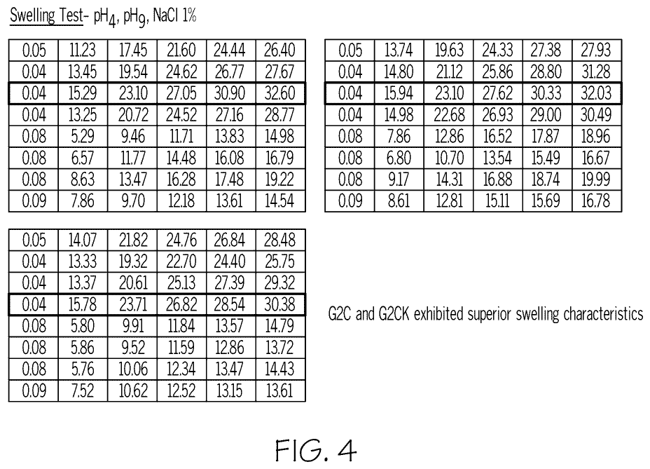

Water uptake capacity is undoubtedly primordial to understanding the SH structure and potential properties. The water absorption capacity of the synthesized hydrogels was studied in distilled water (FIGS. 3A-3C), standard saline solution, and acidic and basic solutions (FIG. 4). The calculated amount of hydrogel powder of 100-150 mesh size (measured by standard sieve analysis), was accurately weighed in triplicate for each treatment and put into 250 ml beakers. To these beakers, surplus distilled water or different solutions were added to facilitate absorption. After regular time intervals of 1, 2, 4, 6, and 12 h, the swollen hydrogels were drained through fine, non-sticky fabric cloth of nearly 200 mesh size until free water was completely drained off. For practical purposes, maximum water absorption was measured directly after 12 h and readings for intermediate swelling were taken with different sets to avoid loss of hydrogel during draining. The results further demonstrated that the Swelling Ratio for G2C and G2CK were nearly 750-800%, which is comparable with the synthetic polymers available commercially.

### Example 1.3. Chlorophyll Tests

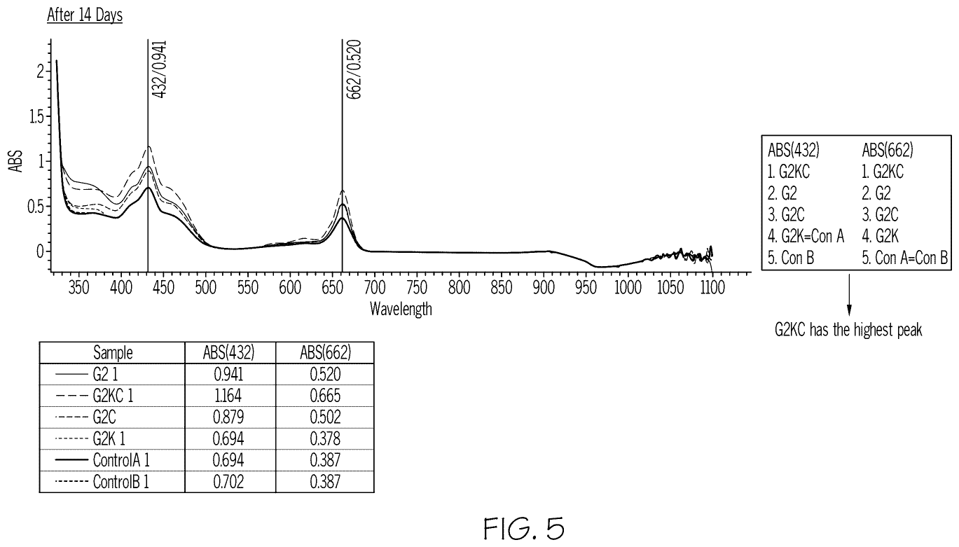

Chlorophyll is the green pigment found in the leaves of green plants. The amount of chlorophyll in the leaves is a great indication of the health of the plant and is almost directly proportional to the Nitrogen content in the leaves. FIG. 5 exhibits the chlorophyll test using different samples.

### Example 1.4. Application of the Hydrogels in Sustainable Farming

To investigate the efficacy of the prepared Superabsorbent Hydrogel (SH) in terms of water retention capacity in the soil and controlled release of nutrients, two model plants were taken: (a) Black Chickpeas, and (b) Fenugreek. A total of 24 g of soil (18 g of pure soil+6 g of SH) were prepared. The controls were soil without Applicant's developed hydrogel. In each group, 3 Fenugreek seeds and 2 Chickpeas were planted. After planting the seeds, no further watering was provided, and the growth of the plants was observed over time.

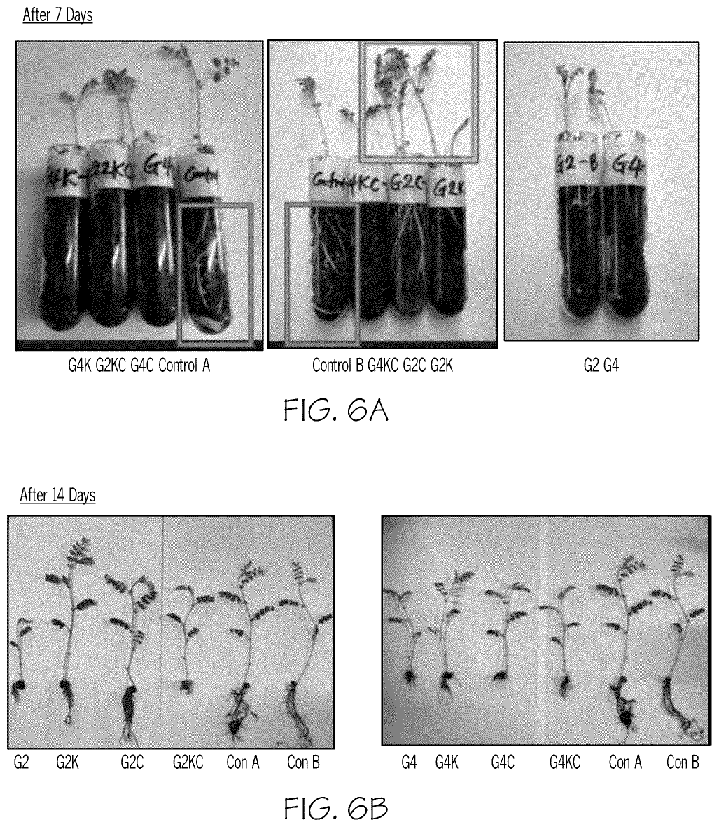

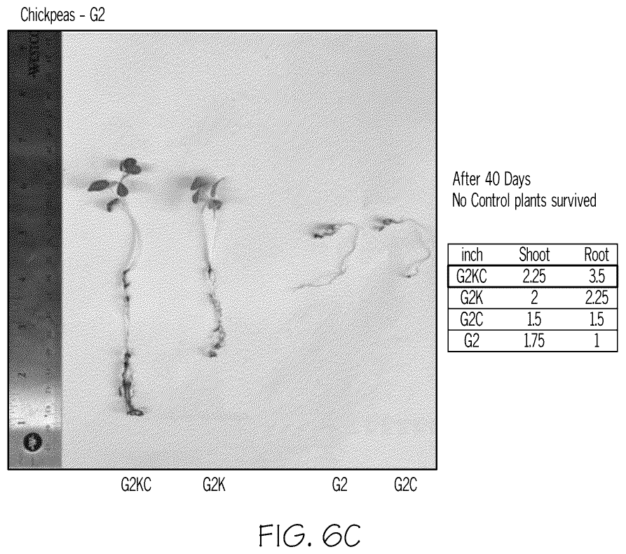

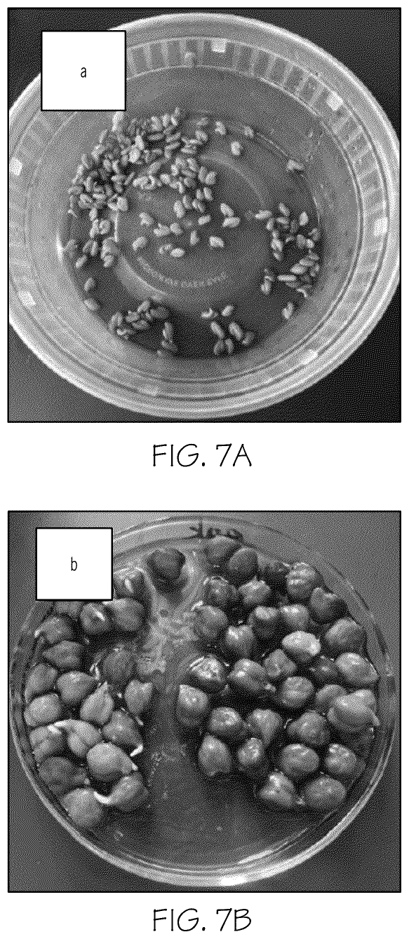

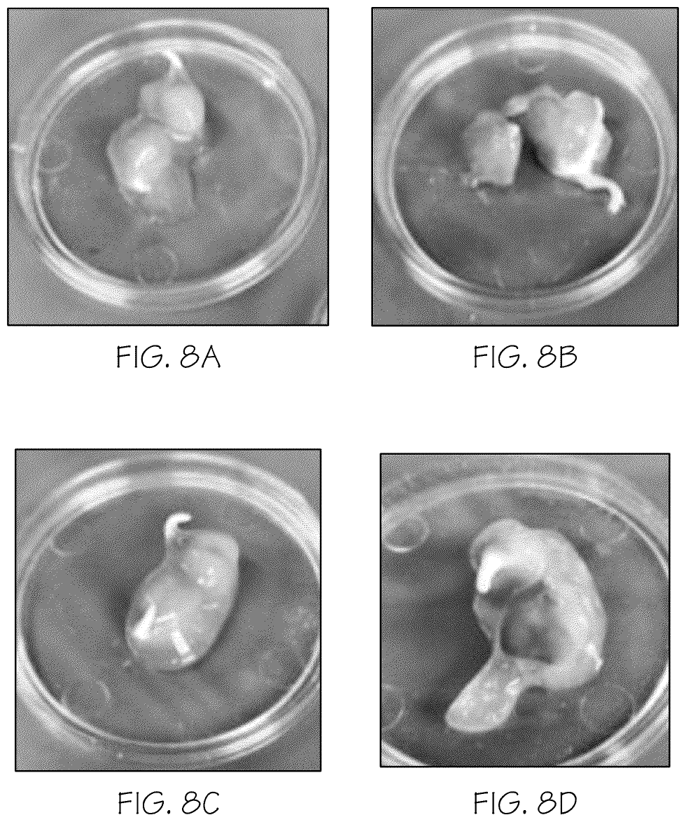

The results demonstrated that synthesized hydrogels were a superior substitute in boosting the soil's capacity to retain water. FIGS. 6A-6C exhibit the growth of Chickpeas plants in 7 days, 14 days, and after 40 days of planting the seeds in the soil mixed with and without Applicant's fabricated SHs.

### Example 1.5. SH Biodegradability

The weight of the soil mixed with synthesized hydrogels was measured after 60 days. The result exhibited that the difference in the initial and final weight of the soil was negligible, which further demonstrated that the synthesized SH was completely biodegradable. The biodegradable nature of the synthesized hydrogel was also confirmed with presence of molds in the sample with only Chitosan and Gum mix. Addition of Kaolin inhibited the growth of molds.

### Example 1.6. Materials and Methods

Guar gum and Kaolin utilized in this Example were purchased from Sigma-Aldrich (Germany). Chitosan was purchased from Thermo fisher. Sodium Chloride, Sodium Hydroxide, Acetic acid, and Acetone were prepared by Fisher chemical.

### Example 1.7. Swelling Test

The swelling characteristics of the guar gum are studied at distilled water, buffer solution at pH 4.0, pH 9.0 and brine. The pH solution was prepared by using pH-meter (Model: XL600, Fisher brand). Hydrogel pieces of 2.0 g were soaked in the solutions and masses were measured at intervals of times of 30, 60, 90, and 120 min. The degrees of swelling were calculated using Equation 1.

$${S}_{eq} ( \% ) = \frac{{W}_{t} - {W}_{d}}{{W}_{d}} \times 100 \qquad Equation 1$$

### Example 1.8. Experiments Conducted with Plants (Plant Growth)

About 24 g of soil were mixed with 18 g of pure soil soaked with distilled water and 6 g of each hydrogel. The control group without hydrogel and the experimental group were also set up. In each group, 3 Fenugreek seeds and 2 Chickpeas were planted (FIGS. 7A-7B). After planting the seeds, no further watering was provided, and the growth of the plants was observed over time. The pH4 and pH9 groups of samples were also prepared for Chickpeas. After 7 and 14 days, Applicant checked the height of the plants and the amount of chlorophyll content were measured using UV-vis.

### Example 1.9. Experiments Conducted with Cheek Peas and Fenugreek-Non-Toxicity and Biocompatibility

Chickpeas seeds samples were planted solely in hydrogel. Prominent sprouting was observed in the following four samples (G4KC, G4C, G2K, G4). This indicates that this fabricated hydrogel is non-toxic, biodegradable, and biocompatible unlike synthetic hydrogels, providing evidence of their safety for sustainable agriculture (FIGS. 8A-8D).

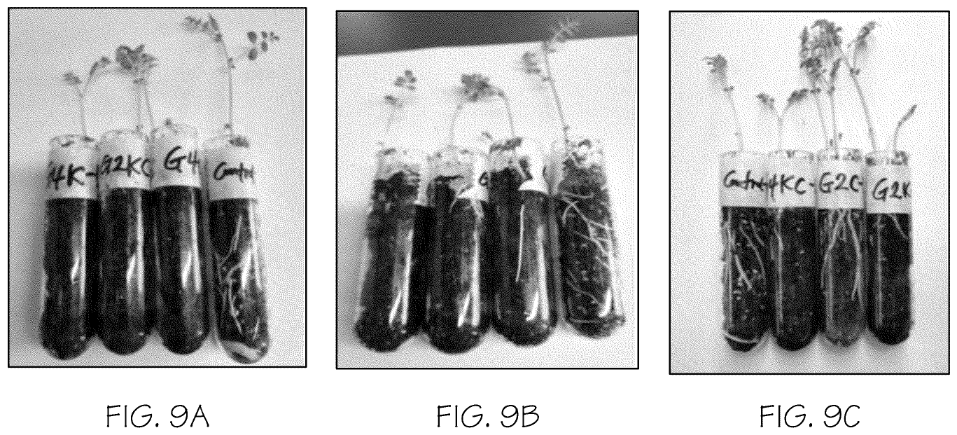

After 7 days since planting in the soil, it was observed that all samples exhibited successful seed germination. The control sample also showed rapid plant growth, but compared to other samples, it had significantly longer root growth (FIGS. 9A-9C).

### Example 1.10. Summary

In summary, the hydrogel in this Example is synthesized from a natural gum-based polysaccharide, GG, to which chitosan and clay are added. Natural GG was extracted from the seeds of Cyamopsis tetragonolobus and was evaluated in 2-4% w/v concentrations in combination with chitosan (C), a nontoxic, water-soluble polysaccharide obtained from the shells of crabs and shrimps, and kaolinite (K), a clay. Eight different blends of these materials were created using 2-4% w/v of the GG with fixed amounts of C and K, and their performance as an SH was evaluated using two control plants: fenugreek and black chickpeas.

The SH blends showed optimal gelling properties (FIGS. 2A-2C). In particular, qualitative tests showed that a 2% GG and C SH formulation had the highest gelation capability, followed by a 2% GG plus both C and K SH blend and a 2% GG SH formulation.

The SH blends also showed optimal H₂O uptake capacities (FIGS. 3A-3C and 4). In particular, the H₂O uptake capability of the various SH blends was evaluated using distilled water, saline water (1% NaCl), and acidic and basic solutions of pH 4 and 9. A sample of 2% GG and C realized an 815% increase in weight after 120 minutes of exposure to a pH 4 water solution. A sample of 2% GG and C realized an 800% increase in weight after 120 minutes of exposure to a pH 9 solution. A sample of 2% GG plus both C and K realized a 760% increase in weight after 120 minutes of exposure to a 1% NaCl saline water solution.

The SH blends also showed optimal chlorophyll enhancement capabilities in plants (FIG. 5). In particular, the chlorophyll content of black chickpeas leaves was assessed via spectral analysis after exposure to different SH blends for 14 days. The 2% GG plus C and K SH blend resulted in the highest level of chlorophyll in the leaves.

Additionally, the SH blends demonstrated optimal plant growth (FIGS. 6A-6C). In particular, the effectiveness of the SH on the growth of fenugreek and black chickpeas was evaluated by comparing the use of 18 grams of soil without an SH as a growth medium to 18 grams of soil sample plus 6 grams of the developed SH as a growth medium on a series of seeds over 40 days. After 40 days of growth, the black chickpea seeds planted in soil without an SH were dead (FIG. 6C). The soil sample containing the 2% GG plus C and K SH blend resulted in a plant shoot length of 2.25 inches and a root length of 3.5 inches. The 2% G plus K SH blend resulted in a plant shoot length of 2 inches and a root length of 2.25 inches.

The SH blends also showed biodegradability. The soils containing the SH used during the 40-day growth tests were weighed after 60 days, with the initial soil weight and the 60-day soil weight being comparable, indicative of the SH's biodegradability. The hydrogel added (6 g) to the soil (18 g) has been used up for providing water to the germinating plants for the 40 days growth test. The final weight of the soil after 60 days was measured, and the result recorded was 17.35 g.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A hydrogel comprising:
one or more galactomannans;
one or more biodegradable polymers; and
one or more clays.

2. The hydrogel of claim 1, wherein the galactomannans are selected from the group consisting of guar gum, fenugreek gum, xanthan gum, locust bean gum, Arabic gum, tara gum, cassia gum, or combinations thereof.

3. The hydrogel of claim 1, wherein the galactomannans comprise guar gum.

4. The hydrogel of claim 1, wherein the biodegradable polymers are selected from the group consisting of agro-polymers, polysaccharides, proteins, biopolymers, bio-polyesters, or combinations thereof.

5. The hydrogel of claim 1, wherein the biodegradable polymers comprise one or more polysaccharides.

6. The hydrogel of claim 5, wherein the polysaccharides are selected from the group consisting of starch, glycogen, galactogen, arabinoxylans, cellulose, chitin, chitosan, pectin, or combinations thereof.

7. The hydrogel of claim 5, wherein the polysaccharides comprise chitosan.

8. The hydrogel of claim 1, wherein the clays are selected from the group consisting of kaolin clays, kaolinite clays, ball clays, fire clays, bentonite clays, or combinations thereof.

9. The hydrogel of claim 1, wherein the clays comprise kaolin clays and kaolinite clays.

10. The hydrogel of claim 1, wherein the hydrogel further comprises one or more compounds.

11. The hydrogel of claim 10, wherein the one or more compounds are selected from the group consisting of nutrients, agrochemicals, pesticides, herbicides, fertilizers, or combinations thereof.

12. The hydrogel of claim 1, wherein the hydrogel is biodegradable.

13. The hydrogel of claim 1, wherein the hydrogel is operable to retain water at more than 500 times the hydrogel's weight.

14. The hydrogel of claim 1, wherein the hydrogel is operable to retain water at more than 700 times the hydrogel's weight.

15. A method of treating a soil, said method comprising
adding a hydrogel to the soil, wherein the hydrogel comprises:
one or more galactomannans;
one or more biodegradable polymers; and
one or more clays.

16. The method of claim 15, wherein the soil is associated with an agricultural field.

17. The method of claim 15, wherein the adding enhances the growth rate of plants or seeds.

18. The method of claim 17, further comprising a step of growing the plants or seeds in the soil.

19. The method of claim 15, wherein the galactomannans are selected from the group consisting of guar gum, fenugreek gum, xanthan gum, locust bean gum, Arabic gum, tara gum, cassia gum, or combinations thereof.

20. The method of claim 15, wherein the biodegradable polymers are selected from the group consisting of agro-polymers, polysaccharides, proteins, biopolymers, bio-polyesters, or combinations thereof.

21. The method of claim 15, wherein the biodegradable polymers comprise one or more polysaccharides.

22. The method of claim 15, wherein the clays are selected from the group consisting of kaolin clays, kaolinite clays, ball clays, fire clays, bentonite clays, or combinations thereof.

23. The method of claim 15, wherein the hydrogel further comprises one or more compounds.

24. The method of claim 23, wherein the one or more compounds are selected from the group consisting of nutrients, agrochemicals, pesticides, herbicides, fertilizers, or combinations thereof.

25. A method of making a hydrogel, said method comprising:
associating one or more galactomannans with at least one or more biodegradable polymers and one or more clays.

26. The method of claim 25, wherein the associating comprises mixing the galactomannans with the biodegradable polymers and the clays to form a mixture.

27. The method of claim 25, wherein the associating further comprises heating the mixture.

28. The method of claim 25, wherein the associating comprises:
mixing the galactomannans with the biodegradable polymers to form a mixture; and
adding the clays to the mixture.

29. The method of claim 28, wherein the mixing comprises heating the mixture.

30. The method of claim 25, wherein the galactomannans are selected from the group consisting of guar gum, fenugreek gum, xanthan gum, locust bean gum, Arabic gum, tara gum, cassia gum, or combinations thereof.

31. The method of claim 25, wherein the biodegradable polymers are selected from the group consisting of agro-polymers, polysaccharides, proteins, biopolymers, bio-polyesters, or combinations thereof.

32. The method of claim 25, wherein the biodegradable polymers comprise one or more polysaccharides.

33. The method of claim 25, wherein the clays are selected from the group kaolin clays, kaolinite clays, ball clays, fire clays, bentonite clays, or combinations thereof.

34. The method of claim 25, further comprising a step of associating the hydrogel with one or more compounds.

35. The method of claim 34, wherein the one or more compounds are selected from the group consisting of nutrients, agrochemicals, pesticides, herbicides, fertilizers, or combinations thereof.
